(19) United States
(12) Patent Application Publication
(10) Pub. No.: US 2005/0210488 A1
(43) Pub. Date: Sep. 22, 2005

(54) Optical pickup device

(75) Inventor: Togo Kojima, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd

(21) Appl. No.: 11/070,272

(22) Filed: Mar. 3, 2005

(30) Foreign Application Priority Data
Mar. 4, 2004 (JP) P2004-060933

(51) Int. Cl. G11B 7/00

(52) U.S. Cl. 720/681

(57) ABSTRACT

Other end portion of a wire member 6 having elasticity one end portion of which is fixed to a fixed support member 2 is fixed to a movable lens holder 3 having an object lens 31. The wire member 6 is arranged to penetrate through a layer of a damper member 8 filled to a filling portion 7 of the fixed support member 2. The filling portion 7 is formed by a groove-like face 71 and an inner face 21a of a lid portion 21. The lid portion 21 is provided with a damper member filling port 22. A front and rear width c and an up and down width d of the damper member filling port 22 are narrower than a front and rear width a and an up and down width b of a groove shaped hollow portion.

### BACKGROUND OF THE INVENTION

1. Field of the Invention

The present invention relates to an optical pickup device mounted to an optical disk drive, in details, relates to an optical pickup device having a lens unit in which a movable lens holder having an object lens is supported by a wire member having elasticity extended from a fixed support member displaceably in a cantilever state.

2. Description of the Related Art

An optical pickup device mounted to an optical disk drive is used for writing or reading data by converging laser light to a disk face as a record medium and is provided with a function of controlling a position of an object lens in a focus direction or in a tracking direction in accordance with face swinging or eccentricity in rotating a disk.

FIG. 4 shows an outline of a lens unit 1 are adopted in an optical pickup device of a background art. The lens unit 1 of the drawing is mounted to a base (not illustrated) driven to travel in a radius direction of a disk and is provided with a fixed support member 2 fixed to the base, a movable lens holder 3 having an object lens 31, a wiring board 4 fixedly attached to a rear end face of the fixed support member 2, terminal plates 5, 5 fixedly attached to respectives of both side faces of the movable lens holder 3 disposed in a left and right direction, conductive wire members 6 having elasticity arranged on both left and right sides of the lens unit 1 by the same numbers of pieces, and mounted with a plurality of coils (not illustrated) or the like for exerting an urge force in a focus direction For a tracking direction T, and distal ends of the coils are connected to patterns of the terminal boards 5. Further, the plurality of pieces of wire members 6 and the terminal plates 5, mentioned above, are symmetrically arranged on the both left and right sides of the lens unit 1, and there is a case of three pieces of the wire member 6 on one side as in the illustrated example, or a case of two pieces thereof on one side although not illustrated. Further, by soldering to fix one end portion 61 of the wire member 6 to a land of the wiring board 4 and soldering to fix other end portion 62 thereof to a land of the terminal plate 5, the movable lens holder 3 is supported by the fixed support member 2 displaceably in a cantilever state via the plurality of pieces of wire members 6. Numerals 41, 51 designate solder. Further, filling portions 7 having the same volume are provided at pluralities of portions of respective side faces of the fixed support member 2 disposed in a left and right direction and the wire members 6 are penetrated through layers of damper members (not illustrated in FIG. 4) filled to the filling portions 7.

In the lens unit 1 of FIG. 4, when current is made to flow to a pattern of the wiring board 4, electricity is conducted to the coils via the wiring board 4, the wire members 6, and the terminal plates 5, the coils exert the urge force in the focus direction or the tracking direction and the movable lens holder 5 is driven to displace in the focus direction F or the tracking direction T along with the object lens 31.

FIG. 5 is a front view showing to enlarge an essential portion of the fixed support member 2. In the drawing, numeral 8 designates a damper member filled to the filling portion 7 (refer to FIG. 4) and the wire member 6 is penetrated through the layer of the damper member 8. The damper member 8 comprises a gel-like substance of a photo-currying type, a thermosetting type or the like and achieves an operation of restraining resonance of the wire member 6 when the movable lens holder 3 is driven to be displaced in accordance with bending deformation of the wire member 6.

As is known from FIG. 4 or FIG. 5, each of the filling portions 7 shown in FIG. 4 is formed by a groove shaped hollow portion surrounded by a groove-like face 71 extended over a total width in a front and rear direction of the fixed support member 2, that is, the grove-like face 71 formed in a channel-like shape or substantially a channel-like shape in front view by an upper face 72, a lower face 73 and a groove bottom face 74, and a total of the groove shaped hollow portion (that is, the filling portion 7) is opened at a side face of the fixed support member 2. Further, an open port 75 thereof is utilized as an injecting port for filling the damper member 8.

Meanwhile, it is publicly known to use a gel-like substance of a self holding type, or a gel-like substance of a photo-curing type or a thermosetting type in order to restrain resonance by damping a biaxial actuator of an object lens drive apparatus (refer to, for example, JP-A-2000-222753). Further, it is also publicly known in an object lens drive apparatus to penetrate a suspension for supporting an object lens holder through a filling portion provided to a suspension holder, injecting a damper member comprising a UV curing type viscoelastic member to the filling portion and forming the above-described filling portion by a filling portion an upper face of which is opened or a filling portion opened in a front and rear direction (refer to, for example, JP-A-10-106000). Further, it is also publicly known in a structure of supporting an object lens for an optical pickup device to penetrate a wire suspended with the object lens through a recess portion of a damper holder and filling a damper member to a surrounding thereof as well as providing a slit having a narrow width at the recess portion over a total length thereof and injecting the damper member to the recess portion by utilizing the slit (refer to, for example, JP-A-11-096572).

### SUMMARY OF THE INVENTION

According to the background art explained in reference to FIG. 4 or FIG. 5, the filling portion 71 for holding the damper member 8 is formed by the groove shaped vacant portion, the total of the groove shaped vacant portion is opened at the side face of the fixed support member 2 and therefore, there is achieved an advantage that the open port 75 can widely be ensured and the damper member 8 is easy to fill, in contrast thereto, it is difficult to fill each of the filling portions 71 having the same volume with a constant amount of the damper member 8. That is, the volume of the damper member 8 is changed by being influenced by temperature of an operational environment or body temperature of an operator, further, a front and rear width a (refer to FIG. 4) of the open port 75 is provided with a width the same as a front and rear width of the groove shaped hollow portion fixed by the groove-like face 71, further, an up and down width b (refer to FIG. 5) of the open port 75 is provided with a width the same as an up and down width of the groove shaped hollow portion and therefore, a layer surface 81 of the damper member 8 filled to the filling portion 71 by utilizing the open port 75 is molded in a recessed shape in an up and down direction at a location of the open port 75 (for example, upper two states of FIG. 5), or molded in a bulged shape (for example, a lower state of FIG. 5), further, the layer surface 81 is molded in a wavy shape in a front and rear direction at the location of the open port 75, and there is a concern that each of the filling portions 71 is difficult to be filled with the constant amount of the damper member 8. Further, when amounts of filling the damper member 8 to the individual faces 71 are significantly dispersed, operation of damping the individual wire members 6 is not uniformly achieved and a characteristic of displacing the movable lens holder 3 and therefore, the object lens 31 is deteriorated, which amounts to a deterioration in the reading and writing function by the optical pickup device.

In this regard, according to a technology described in JP-A-11-096572, that is, a technology of providing the slit having the narrow width over the total length of the recess portion of the damper holder inserted with the wire suspended with the object lens and filled with the damper member over the total length, by determining the up and down width of the slit to be narrower than the up and down width of the recess portion, non-uniformity of the shape in the up and down direction of the layer surface of the damper member is restrained and therefore, it is predicted that the amount of filling the damper member is made to be uniform at the recess portion only in this respect. However, since the front and rear width of the slit becomes the width the same as that of the front and rear width of the recess portion and therefore, it can be said that non-uniformity of a shape in the front and rear direction of the layer surface of the damper member is not restrained and the layer surface is molded in the wavy shape in the front and rear direction to cause to increase a dispersion in the filling amount. Further, it is known that the characteristic of displacing the object lens is deteriorated and the reading and writing function by the optical pickup device is deteriorated also by the dispersion in the filling amount caused by molding the layer surface of the damper member in the wavy shape in the front and rear direction. Further, it is also known that by forming the front and rear width of the slit by the width the same as that of the front and rear width of the recess portion, when the damper member is injected to one point (one portion) in the front and rear direction of the slit, there is a concern of bringing about a drawback of leaking out the damper member injected to the recess portion from other portion of the slit.

The present invention has been carried out in view of the above-descried situation and one of objects thereof is to provide an optical pickup device having a lens unit in which on the basis of the constitution explained in reference to FIG. 4 or FIG. 5, by improving the constitution, the amounts of filling the damper member 8 to the individual filling portions 7 become uniform, further, in filling, there is not a concern of leaking out the damper member from a portion of filling the damper member or a portion at a vicinity thereof.

According to a first aspect of the invention, there is provided an optical pickup device including: a fixed support member having a filling portion in which a damper member is filled; a movable lens holder having an object lens; and a wire member having an elasticity and being fixed to the fixed member at one end thereof and being fixed to the movable lens holder at the other end thereof, wherein the wire member is arranged to penetrate through the damper member filled in the filling portion, wherein the filling portion is formed by a groove-like face formed at a side face of the fixed support member disposed in a left and right direction thereof and extended over a total width in a front and rear direction of the fixed support member and an inner face of a lid portion closing an opening portion of a groove shaped hollow portion surrounded by the groove-like face, wherein the lid portion has a damper member filling port a width of which is formed to be narrower than a front and rear width of the groove shaped hollow portion, wherein an up and down width of the damper member filling port is configured to be narrower than an up and down width of the groove shaped hollow portion, and wherein the groove-like face is formed in a channel-like shape or substantially in a channel-like shape in a front view by an upper face, a lower face and a groove bottom face and the lid portion is integrally formed with the fixed support member.

According to a second aspect of the invention, there is provided an optical pickup device including: a fixed support member having a filling portion in which a damper member is filled; a movable lens holder having an object lens; and a wire member having an elasticity and being fixed to the fixed member at one end thereof and being fixed to the movable lens holder at the other end thereof, wherein the wire member is arranged to penetrate through the damper member filled in the filling portion, wherein the filling portion is formed by a groove-like face formed at a side face of the fixed support member disposed in a left and right direction thereof and extended over a total width in a front and rear direction of the fixed support member and an inner face of a lid portion closing an opening portion of a groove shaped hollow portion surrounded by the groove-like face, and wherein the lid portion has a damper member filling port a width of which is formed to be narrower than a front and rear width of the groove shaped hollow portion.

### BRIEF DESCRIPTION OF THE DRAWINGS

The above objects and advantages of the present invention will become more apparent by describing preferred exemplary embodiments thereof in detail with reference to the accompanying drawings, wherein:

FIG. 1 is an outline perspective view of a lens unit adopted in an optical pickup device according to an embodiment;

FIG. 2 is a partially broken front view showing to enlarge an essential portion of a fixed support member;

FIG. 3 is an outline perspective view showing to enlarge the essential portion of the fixed support member;

FIG. 4 is an outline perspective view of a lens unit adopted in an optical pickup device of a background art; and

FIG. 5 is a front view showing to enlarge an essential portion of a fixed support member of FIG. 4.

### DETAILED DESCRIPTION OF THE PREFERRED EMBODIMENTS

Now referring to the attached drawings as the occasion demands, an explanation will be given of a best mode for carrying out the invention.

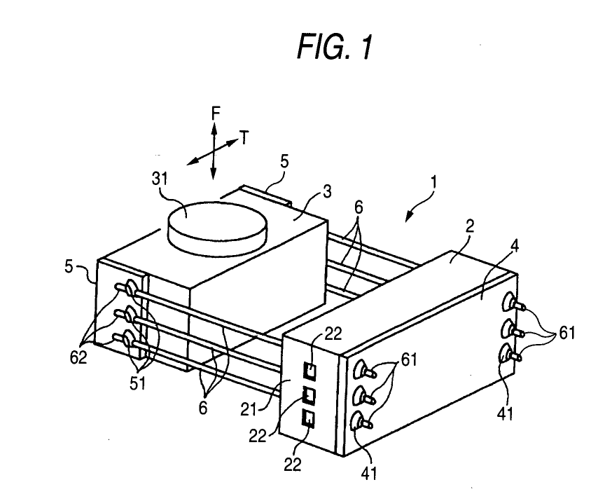

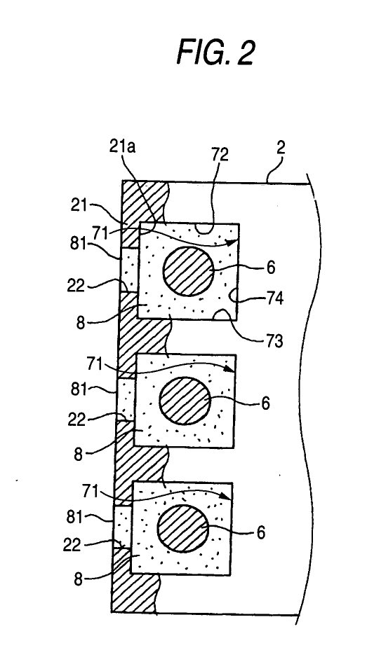

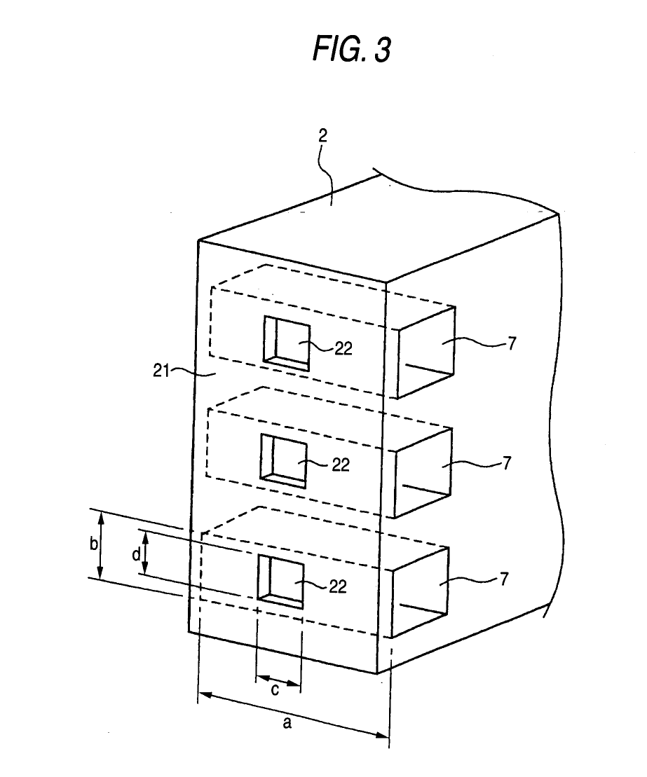

FIG. 1 is an outline perspective view of the lens unit 1 adopted in the optical pickup device according to the invention, FIG. 2 is a partially broken front view showing to enlarge the essential portion of the fixed support member 2, and FIG. 3 is an outline perspective view showing to enlarge the essential portion of the fixed support member 2.

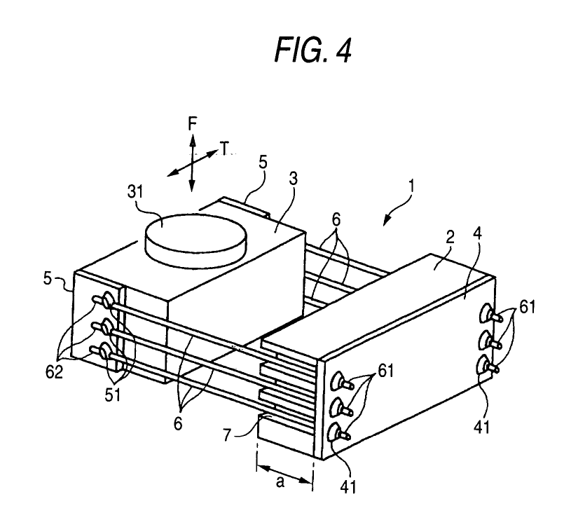

A point of differing the lens unit 1 of FIG. 1 from the lens unit 1 explained in reference to FIG. 4 resides in that the fixed support member 2 is integrally formed with a lid portion 21 and the lid portion 21 is provided with a damper member filling port 22. The other items, for example, that the fixed support member 2 of the lens unit 1 is fixed to the base (not illustrated) driven to travel in the radius direction of the disk, that the movable lens holder 3 is mounted with the plurality of coils (not illustrated) for exerting the urge force in the focus direction F or the tracking direction T, and the distal ends of the coils are connected to the patterns of the terminal plates 5 and the like are similar to those explained in reference to FIG. 4. Therefore, in the lens unit 1 of FIG. 1, when current is made to flow to the pattern of the wiring board 4, the electricity is conducted to the coils via the wiring board 4, the pluralities of pieces of wire members 6, the terminal plates 5, 5 and the coils exert the urge force in the focus direction F or the tracking direction T, thereby, the movable lens holder 5 is driven to displace in the focus direction F or the tracking direction T in accordance with displacement of the wire members 6 along with the object lens 31.

According to the embodiment, the filling portion 7 formed by each of the both side faces of the fixed support member 2 disposed in the left and right direction is formed by the groove-like face 71 extended over the total width in the front and rear direction of the fixed support member 2 shown in FIG. 2 and an inner face 21a of the lid portion 21 closing the opening portion of the groove shaped hollow portion surrounded by the groove-like face 71, and the groove-like face 71 is formed in the channel-like shape or substantially in the channel-like shape in front view by the upper face 72, the lower face 73 and the groove bottom face 74. The point is similar to that explained in reference to FIG. 4.

As is known in reference to FIG. 3, according to the damper member filling port 22, a front and rear width c thereof is narrower than the front and rear width a of the groove shaped hollow portion surrounded by the groove-like face 71, further, an up and down width d thereof is narrower than the up and down width b of the groove shaped hollow portion and the damper member filling port 22 is opened at a center portion in the front and rear direction of the groove shaped hollow portion. Further, it is preferable to form the damper member filling port 22 as upper as possible within a range of communicating with the groove shaped hollow portion.

According to the embodiment, each of the filling portions 7 is opened at the side face of the fixed support member 2 only at the portion of forming the damper member filling port 22, further, the front and rear width c and the up and down width d of the damper member filling port 22 are formed to be narrower than the front and rear width a and the up and down width b of the groove shaped hollow portion forming the filling portion 7 and therefore, a size of the damper member filling port 22 is small. Therefore, when the damper member 8 is filled from the damper member filling port 22, the concern of molding the layer surface 81 of the damper member 8 in the wavy shape in the front and rear direction and forming the layer surface 81 in the recessed shape or the bulged shape in the up and down direction is extremely reduced and not only the amounts of filling the damper member 8 to the individual filling portions 7 become uniform but also in filling, there is not a concern of leaking out the damper member 8 from the damper member filling port 22.

Although according to the embodiment, the damper member filling port 22 is formed in a rectangular shape or a square shape, in this respect, the damper member filling port 22 may be formed in a circular shape. Further, when the damper member filling port 22 is formed as upper as possible within the range of communicating with the groove shaped hollow portion, there is achieved an advantage that the damper member 8 filled from the damper member filling port 22 is easy to distribute uniformly to the total of the filling portion 7.

According to the embodiment, the filling portion filled with the damper member is opened at the side face of the fixed support member only at a portion of forming the damper member filling port, further, the damper member filling port is formed to be narrower than the front and rear width of the groove shaped hollow portion forming the filling portion and therefore, when the damper member is filled from the damper member filling port, a concern of forming a layer surface of the damper member in a wavy shape in the front and rear direction is extremely reduced. Therefore, amounts of filling the damper member to the individual filling portions become uniform. Further, since the width of the damper member filling port is narrow, in filling, there is not a concern of leaking out the damper member from a portion of filling the damper member or a portion at a vicinity thereof. Further, in a lens unit of a general optical pickup device, the up and down width of the filling portion provided to the fixed support member is very short and therefore, even when the layer surface of the damper member is molded in the recessed shape or the bulged shape in the up and down direction at the location of the filling port, it is difficult to bring about a situation that amounts of filling the damper member to the individual filling portions are significantly dispersed thereby.

In the embodiment, it is preferable that the up and down width of the damper member filling port becomes narrower than the up and down width of the groove shaped hollow portion, according thereto, even when the layer surface of the damper member is molded in the recessed shape or the bulged shape in the up and down direction at the location of the filling port having the narrow front and rear width, there is not brought about the situation in which the amounts of filling the damper member to the individual filling portions are significantly dispersed thereby.

In the embodiment, it is preferable to form the groove-like face in a channel-like shape or substantially in a channel-like shape in a front view by an upper face, a lower face and a groove bottom face and form the lid portion integrally with the fixed support member. According thereto, it is not necessary to constitute the lid portion by a separate part and therefore, the amounts of filling the damper member to the individual filling portions can be made to be uniform without increasing a number of parts.

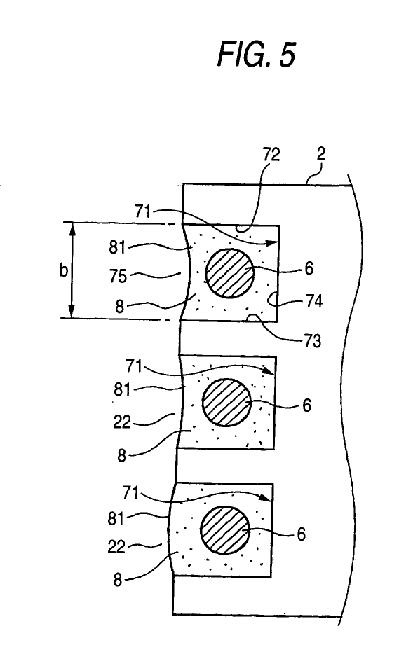

According to the embodiment, the amounts of filling the damper member to the individual filling portions can be made to be uniform by constituting a basic constitution by the constitution explained in reference to FIG. 4 or FIG. 5 and adding a simple constitution of only adding the lid portion thereto. Therefore, there is achieved an advantage of not deteriorating a characteristic of displacing an object lens caused by a dispersion in the amounts of filling the damper member to the individual filling portions and deteriorating a reading and writing function by the optical pickup device thereby.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

1. An optical pickup device comprising:
a fixed support member having a filling portion in which a damper member is filled;
a movable lens holder having an object lens; and
a wire member having an elasticity and being fixed to the fixed member at one end thereof and being fixed to the movable lens holder at the other end thereof,
wherein the wire member is arranged to penetrate through the damper member filled in the filling portion,
wherein the filling portion is formed by a groove-like face formed at a side face of the fixed support member disposed in a left and right direction thereof and extended over a total width in a front and rear direction of the fixed support member and an inner face of a lid portion closing an opening portion of a groove shaped hollow portion surrounded by the groove-like face,
wherein the lid portion has a damper member filling port a width of which is formed to be narrower than a front and rear width of the groove shaped hollow portion,
wherein an up and down width of the damper member filling port is configured to be narrower than an up and down width of the groove shaped hollow portion, and
wherein the groove-like face is formed in a channel-like shape or substantially in a channel-like shape in a front view by an upper face, a lower face and a groove bottom face and the lid portion is integrally formed with the fixed support member.

2. An optical pickup device comprising:
a fixed support member having a filling portion in which a damper member is filled;
a movable lens holder having an object lens; and
a wire member having an elasticity and being fixed to the fixed member at one end thereof and being fixed to the movable lens holder at the other end thereof,
wherein the wire member is arranged to penetrate through the damper member filled in the filling portion,
wherein the filling portion is formed by a groove-like face formed at a side face of the fixed support member disposed in a left and right direction thereof and extended over a total width in a front and rear direction of the fixed support member and an inner face of a lid portion closing an opening portion of a groove shaped hollow portion surrounded by the groove-like face, and
wherein the lid portion has a damper member filling port a width of which is formed to be narrower than a front and rear width of the groove shaped hollow portion.

3. The optical pickup device according to claim 2, wherein an up and down width of the damper member filling port is configured to be narrower than an up and down width of the groove shaped hollow portion.

4. The optical pickup device according to claim 2, wherein the groove-like face is formed in a channel-like shape or substantially in a channel-like shape in a front view by an upper face, a lower face and a groove bottom face and the lid portion is integrally formed with the fixed support member.
